(19) United States
(12) Patent Application Publication
(10) Pub. No.: US 2026/0180963 A1
(43) Pub. Date: Jun. 25, 2026

(54) WIRELESS COMMUNICATION METHOD, USER EQUIPMENT, AND STORAGE MEDIUM

(71) Applicant: INNOPEAK TECHNOLOGY, INC., Palo Alto, CA (US)

(72) Inventor: Marcus WONG, Palo Alto, CA (US)

(21) Appl. No.: 19/507,294

(22) PCT Filed: Oct. 15, 2024
(86) PCT No.: PCT/US2024/051349

§ 371 Date: Jan. 30, 2026

Related U.S. Application Data
(60) Provisional application No. 63/545,508, filed on Oct. 24, 2023.

(51) Int. Cl. H04L 9/40

(52) U.S. Cl. CPC H04L 63/061; H04L 63/0428; H04L 63/123

(57) ABSTRACT

A wireless communication method of charging by a first user equipment (UE) includes performing an authorization and policy provisioning with a second UE, performing a UE-to-UE relay discovery and selection with the second UE, establishing a link with a relay providing a relay service to the first UE and the second UE, establishing security credentials to start a secure communication with the second UE, and starting a procedure for reconciling a charging record by sending a copy of a charging record to the relay and the second UE during the secure communication.

### CROSS REFERENCE TO RELATED APPLICATIONS

This application is U.S. National Stage entry of International Application No. PCT/US2024/051349, filed on Oct. 15, 2024, which claims priority to U.S. Provisional Application No. 63/545,508, entitled “METHOD FOR SECURE CHARGING IN 5G PROXIMITY SERVICE,” filed on Oct. 24, 2023, the entire disclosures of which are hereby incorporated by reference.

### TECHNICAL FIELD

The present disclosure relates to the field of communication systems, and more particularly, to a wireless communication method, a user equipment, and a storage medium.

### BACKGROUND

In current wireless communication systems, secure charging mechanisms for proximity services are unavailable. Proximity services (ProSe), as offered in 4G LTE networks, have been primarily designed for public safety purposes, such as for use by first responders in emergency situations. Charging models for such public safety-based ProSe are typically subscription-based, where fees are not tied to the amount of data transmitted or received. Instead, these services are either provided free of charge to first responders or offered through flat-rate subscription plans.

With the increasing commercialization of proximity services beyond public safety applications, there is a growing need for wireless operators to implement new charging mechanisms. These mechanisms should not only support flat-rate or subscription models but also account for usage-based charging, where fees are determined by the volume of data transmitted or received by the user. Additionally, these charging methods should ensure security, reliability, and detailed accuracy, while being resistant to disputes, in order to maintain the integrity and trustworthiness of billing processes for commercialized proximity services. This is essential for operators to accurately capture and bill for usage, ensuring transparent and indisputable transactions.

Therefore, there is a need for apparatuses and wireless communication methods of charging such as a user equipment, a base station, and wireless communication methods for secure charging in a 5G proximity service.

### SUMMARY

In a first aspect of the present disclosure, a wireless communication method of charging by a first user equipment (UE), includes performing an authorization and policy provisioning with a second UE, performing a UE-to-UE relay discovery and selection with the second UE, establishing a link with a relay providing a relay service to the first UE and the second UE, establishing security credentials to start a secure communication with the second UE, and starting a procedure for reconciling a charging record by sending a copy of a charging record to the relay and the second UE during the secure communication.

In a second aspect of the present disclosure, a first user equipment includes a memory, a transceiver, and a processor coupled to the memory and the transceiver. The first user equipment is configured to perform the above method.

In a third aspect of the present disclosure, a non-transitory computer-readable storage medium storing a computer program which, when executed by a computer, causes the computer to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of an example of charging/billing in a fifth generation (5G) communication system.

FIG. 2 is a block diagram of a first user equipment (UE) and a base station of communication in a communication system according to an embodiment of the present disclosure.

FIG. 3 is a block diagram of a first UE according to an embodiment of the present disclosure.

FIG. 4 is a block diagram of a first UE according to an embodiment of the present disclosure.

FIG. 5 is a flowchart illustrating a wireless communication method of charging performed by a first UE according to an embodiment of the present disclosure.

FIG. 6 is a block diagram of secure charging of proximity service in 5G according to an embodiment of the present disclosure.

FIG. 7 is a block diagram of secure communication between UE1 and UE2 via a relay according to an embodiment of the present disclosure.

FIG. 8 is a diagram illustrating an example of charging record according to an embodiment of the present disclosure.

FIG. 9 is a diagram illustrating an example of UE1's signed charging record according to an embodiment of the present disclosure.

FIG. 10 is a diagram illustrating an example of UE2 reconciling charging record according to an embodiment of the present disclosure.

FIG. 11 is a flowchart illustrating an example of end-to-end communication call flow where UEs and relay maintain and reconcile charging records during an off-network communication session via a relay according to an embodiment of the present disclosure.

FIG. 12 is a block diagram of an example of a computing device according to an embodiment of the present disclosure.

FIG. 13 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a future 5th generation (5G) system (may also be called a new radio (NR) system), an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), or other communication systems, etc.

Optionally, a first user equipment (UE) mentioned in the embodiments of the present application may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum, or the communication system in the embodiment of the present application may also be applied to a licensed spectrum, where the licensed spectrum can also be considered an unshared spectrum.

5G Proximity Service provides ability for two UEs out-of-network coverage to be able to communicate with each other via a relay (e.g., UE-to-UE relay or UE-to-Network relay). Any service offered by the mobile network operator (MNO) is expected to be billed to the subscribers (e.g., users of the service), and service records used for billing are generated by network functions and collected by network charging and billing system. The service provided by the mobile network operator (MNO) is designed to be chargeable to the subscribers using the service.

FIG. 1 illustrates a typical charging and billing system where charging details collected by the network entities are sent to a charging system and the billing domain generates the actual bill to be sent to the subscribers for payment. Billing can be based on variety of billing model, such as subscription (e.g., flat-rate or “all-you-can-eat”), based on usage (billed per amount of data), etc. In traditional systems, the network functions typically generate service records for billing purposes, which are collected by the network charging and billing system. These charging details are then processed by a charging system and sent to the billing domain, where the actual bill is generated and issued to the subscribers. This billing may be based on various models, such as a flat-rate subscription, “all-you-can-eat” plans, or usage-based billing (for example, billing per the amount of data transmitted or received).

Since 5G Proximity Service is a service to be provided by the mobile network operator and the operator is expected to be able to charge the first UEs for the use of the service. In this case, the service records cannot be generated by the network. In some embodiments, UEs and relays need to maintain these records reliably and securely and transferred to the network billing system after UEs and relays return to network coverage. In other words, because the first UEs are outside of the network coverage, the network cannot generate the necessary service records in real time. Therefore, in some embodiments, the first UEs and relays participating in the proximity service are responsible for generating, maintaining, and storing service records related to their communication. These service records must be created reliably and securely to ensure accurate billing.

Once the first UEs and relays return to network coverage, the service records are transmitted back to the network billing system. At this point, the charging system processes the service records, and the appropriate billing information is generated. This ensures that the MNO can charge the subscribers for the use of the proximity service, even if the first UEs were out of network coverage when the service was used. Some embodiments also support a variety of billing models for proximity services, including flat-rate subscriptions or usage-based billing, depending on the operator's configuration. Additionally, the secure and reliable transfer of billing data when the first UEs return to network coverage ensures the integrity of the billing process.

Some embodiments of the present disclosure provide a mechanism for providing secure charging in 5G proximity service. In one embodiment, the present disclosure provides a mechanism for enabling secure charging in a 5G proximity service environment, where two User Equipment (UE) devices can communicate out of network coverage via a relay (e.g., UE-to-UE relay or UE-to-Network relay). This embodiment addresses the challenge of ensuring that the mobile network operator (MNO) can generate accurate billing records for such communication, even when the devices are outside the coverage of the network and cannot rely on conventional network-based billing systems.

In some embodiments, when two UEs communicate via proximity service outside network coverage, the relay facilitates communication by transferring data between the two UEs. Since the MNO is responsible for billing the subscribers for their use of the service, it becomes essential to reliably capture the usage details, including the amount of data transmitted or received, for billing purposes. However, as the communication occurs outside network coverage, the network cannot directly generate and store these billing records in real time. In some embodiments, the proposed mechanism involves both the first UEs and the relay maintaining secure and reliable service records during out-of-network communication. These service records, which include information such as the data usage, type of service, and duration of the communication, are stored locally on the devices and the relay in a tamper-resistant format. This ensures the integrity of the billing data, preventing unauthorized modifications or loss of data.

In some embodiments, once the first UEs and relay return to network coverage, the service records are securely transmitted to the MNO's billing system. The transmission occurs via an authenticated and encrypted connection to ensure that the billing data remains confidential and accurate during transit. The billing system then processes these records to generate the final bill based on the applicable billing model. The billing model could include various options, such as flat-rate subscription-based billing, usage-based billing (e.g., billed per amount of data transmitted or received), or a hybrid model combining both. In some embodiments, the first UEs and relay are configured to periodically synchronize their service records with the network when they return to coverage. The synchronization process ensures that any discrepancies or missing records are resolved, providing a complete and accurate account of the proximity service usage. Additionally, the charging system may support a mechanism to prevent billing disputes by including cryptographic signatures or time stamps on the service records. This ensures that the records cannot be altered after the fact, and any discrepancies between the first UEs' and relay's records can be verified against the secure signatures to determine the correct billing information.

Some embodiments provide a comprehensive solution to the challenge of billing for 5G proximity services, ensuring that the MNO can reliably and securely charge users for services provided even when communication occurs outside the network's direct control. By enabling UEs and relays to generate and store billing records, and securely transmit them upon returning to network coverage, the MNO can ensure accurate billing while maintaining data integrity and security.

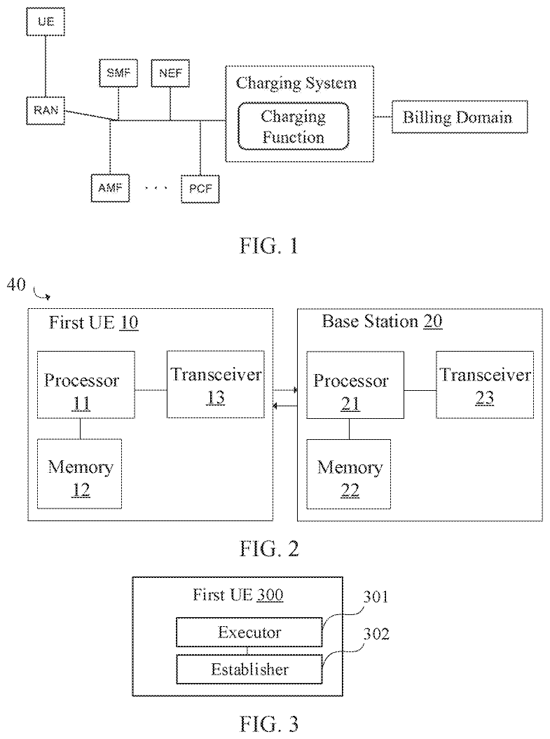

FIG. 2 illustrates that, in some embodiments, a first UE 10 and a base station 20 of communication in a communication system 40. The communication system 40 includes the first UE 10 and the BS 20. The first UE 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to perform an authorization and policy provisioning with a second UE, perform a UE-to-UE relay discovery and selection with the second UE, establish a link with a relay providing a relay service to the first UE and the second UE, establish security credentials to start a secure communication with the second UE, and start a procedure for reconciling a charging record by sending a copy of a charging record to the relay and the second UE during the secure communication. This can solve issues in the prior art and other issues. Further, the proposed some embodiments can provide security, reliability, and detailed accuracy.

FIG. 3 illustrates a first UE 300 according to an embodiment of the present disclosure. The first UE 300 is configured to implement some embodiments of the disclosure. Some embodiments of the disclosure may be implemented into the first UE 300 using any suitably configured hardware and/or software. The first UE 300 includes an executor 301 and an establisher 302. The executor 301 is configured to perform an authorization and policy provisioning with a second UE and configured to perform a UE-to-UE relay discovery and selection with the second UE. The establisher 302 is configured to establish a link with a relay providing a relay service to the first UE and the second UE and configured to establish security credentials to start a secure communication with the second UE. The executor 301 is configured to start a procedure for reconciling a charging record by sending a copy of a charging record to the relay and the second UE during the secure communication. This can solve issues in the prior art and other issues. Further, the proposed some embodiments can provide security, reliability, and detailed accuracy.

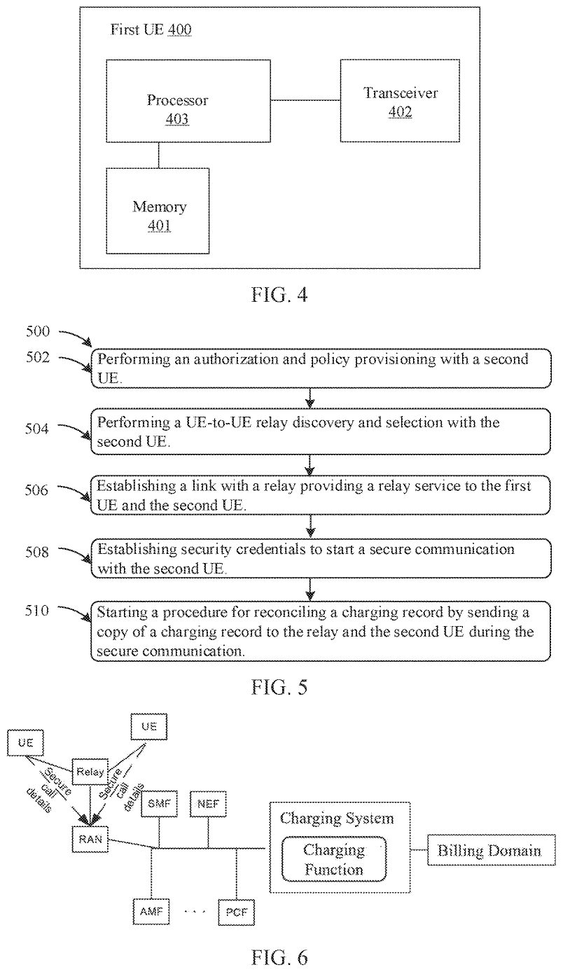

FIG. 4 illustrates a first UE 400 according to an embodiment of the present disclosure. The first UE 400 is configured to implement some embodiments of the disclosure. Some embodiments of the disclosure may be implemented into the first UE 400 using any suitably configured hardware and/or software. The first UE 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 403 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the processor 403 is configured to perform an authorization and policy provisioning with a second UE, perform a UE-to-UE relay discovery and selection with the second UE, establish a link with a relay providing a relay service to the first UE and the second UE, establish security credentials to start a secure communication with the second UE, and start a procedure for reconciling a charging record by sending a copy of a charging record to the relay and the second UE during the secure communication. This can solve issues in the prior art and other issues. Further, the proposed some embodiments can provide security, reliability, and detailed accuracy.

FIG. 5 illustrates a wireless communication method 500 of charging performed by a first UE according to an embodiment of the present disclosure. The wireless communication method 500 of charging performed by the first UE is configured to implement some embodiments of the disclosure. Some embodiments of the disclosure may be implemented into the wireless communication method 500 of charging performed by the first UE using any suitably configured hardware and/or software. In some embodiments, the wireless communication method 500 of charging performed by the first UE includes: an operation 502, performing an authorization and policy provisioning with a second UE, an operation 504, performing a UE-to-UE relay discovery and selection with the second UE, an operation 506, establishing a link with a relay providing a relay service to the first UE and the second UE, an operation 508, establishing security credentials to start a secure communication with the second UE, and an operation 510, starting a procedure for reconciling a charging record by sending a copy of a charging record to the relay and the second UE during the secure communication. This can solve issues in the prior art and other issues. Further, the proposed some embodiments can provide security, reliability, and detailed accuracy.

In some embodiments, performing the authorization and policy provisioning with the second UE includes obtaining security parameters, security policies, and/or parameters used for the first UE to be able to establish communication with the second UE. In some embodiments, performing the first UE-to-UE relay discovery and selection with the second UE includes discovering one or more relays and selecting the relay providing the relay service to the first UE and the second UE. In some embodiments, the secure communication between the first UE and the second UE is a secure end-to-end communication. In some embodiments, the wireless communication, further includes protecting the charging record by computing a cryptographic hash message authentication code (MAC), wherein the MAC is appended to the charging record. In some embodiments, the wireless communication method further includes transmitting a first key to the relay, wherein the first key is used in computing the cryptographic hash MAC for the charging record and is used for protecting the link between the first UE and the relay.

In some embodiments, the wireless communication method further includes transmitting a second key to the second UE, wherein the second key is used in computing the cryptographic hash MAC for the charging record and is used for protecting the secure communication between the first UE and the second UE. In some embodiments, the wireless communication method further includes after reconciliation, the first UE receives reconciled charging records from the second UE and/or relay. In some embodiments, a charging information in the first UE, the relay, and the second UE is synchronized to a granularity. In some embodiments, the wireless communication method further includes transferring the charging record to a network when the first UE is at a network coverage. In some embodiments, a secure charging mechanism is provided for proximity services in a 5G communication system when two User Equipment (UE) devices are communicating outside of network coverage. This embodiment is particularly applicable when UEs communicate via a relay (e.g., UE-to-UE relay), enabling secure charging by the mobile network operator (MNO) even in out-of-network scenarios.

In some embodiments, when UEs are outside network coverage, they can communicate with each other either directly through a side link or indirectly via a relay. The relay assists in facilitating communication between the first UEs by relaying data between them. However, since the first UEs are out of network coverage, traditional network-based charging mechanisms cannot be applied in real-time. To address this, the present disclosure introduces a method by which UEs and the relay securely maintain charging information related to their communication sessions. As the first UEs and relay engage in proximity service communication, they locally store relevant charging details. These details may include, but are not limited to, the duration of communication, data transmitted and received, service type, and usage metrics. The charging details are stored in a secure and tamper-resistant manner, ensuring that the records remain intact and unaltered until the first UEs and relay return to network coverage. Once the first UEs and relay return within network coverage, the stored charging details are collected by the network. This collection occurs securely, typically via an authenticated and encrypted connection, to ensure the integrity and confidentiality of the data during transmission. The charging details are then processed by the MNO's existing charging and billing systems in the same manner as conventional in-network services. The billing system calculates the charges based on the appropriate billing model, such as subscription-based, usage-based, or a hybrid model.

Some embodiments ensure that proximity services, particularly those utilizing a relay for out-of-network communication, are securely billed to the subscriber. The secure storage and transfer of charging data allow the MNO to generate accurate billing records even when the network is not directly involved in real-time communication. By maintaining and transmitting the charging details securely, the integrity of the billing process is upheld, and the subscriber is charged accurately for the proximity services provided.

FIG. 6 illustrates the results of applying this technique, where secure charging of UEs receiving relay service is achieved through the maintenance of charging information by the first UEs and relay. Upon re-entering network coverage, these charging details are seamlessly integrated into the network's charging and billing system, ensuring accurate and secure billing for the proximity service. FIG. 6 illustrates that, in some embodiments, a secure charging process within a 5G network for proximity services is provided. The overall process provides the secure handling and transfer of charging information when UEs communicate via a relay while out of coverage. Once the devices reconnect with the network, the stored charging data is processed for billing. Here is an explanation of the flow based on 5G architecture in FIG. 6: UE (User Equipment): The user devices involved in the communication, one of which is outside of the network coverage and communicating through a relay. Relay: The relay helps route the communication between UEs when they are out of direct coverage, ensuring data exchange. Secure call details are passed from both UEs through the relay to the RAN. RAN (Radio Access Network): Acts as the gateway through which communication details, including secure charging records, are passed to the core network when UEs or relays come within coverage. Core Network Functions: SMF (Session Management Function), NEF (Network Exposure Function), AMF (Access and Mobility Function), PCF (Policy Control Function): These core components of the 5G network manage sessions, policies, and mobility for the first UEs. Charging System: This system receives the secure call details once they are transmitted back into the network. The charging function collects the relevant data for billing. Billing Domain: This is where the final bill is generated based on the charging details transmitted through the network's charging function.

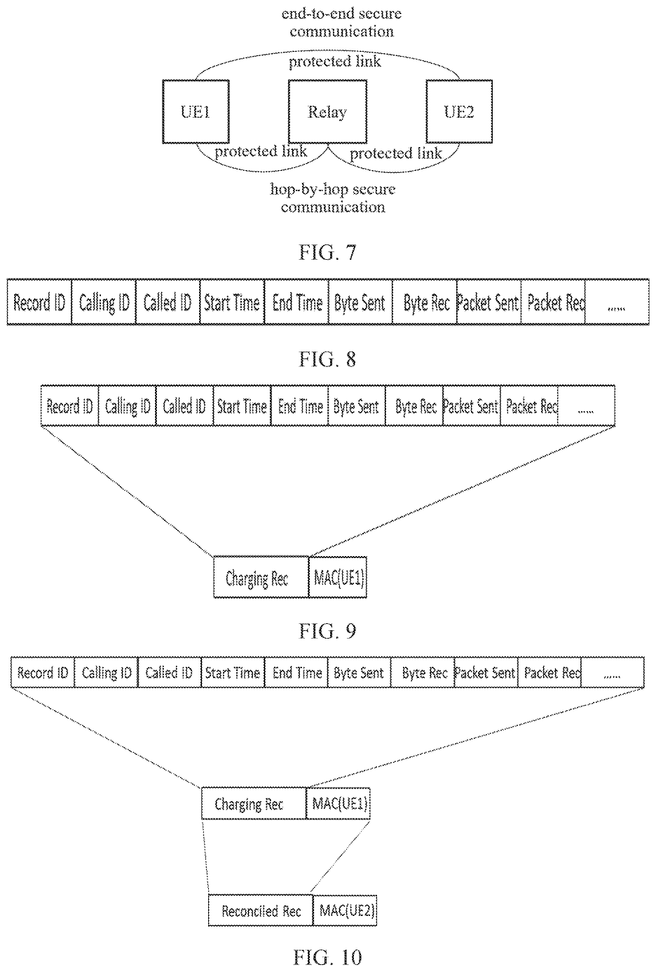

In some embodiments, once UE1 and UE2 establish secure communication (as illustrated in FIG. 7), this communication can be set up either in an end-to-end manner or in a hop-by-hop manner. Upon establishment of the secure communication, UE1, Relay, and UE2 each hold distinct security credentials that ensure the integrity and confidentiality of the communication path. For instance, UE1 and Relay establish a set of security keys (e.g., cipher keys, integrity keys) between them to secure their direct communication. Relay and UE2 similarly establish their own set of security keys to secure their communication link. Additionally, UE1 and UE2 will have their own set of security keys that may operate directly for end-to-end encryption or through the relay in a hop-by-hop method. This security configuration ensures that regardless of whether the communication is direct or via the relay, all links are protected with separate, secure key sets, preserving the confidentiality and integrity of the data being exchanged across the proximity service network.

FIG. 7 illustrates that, in some embodiments, secure communication links between two UEs are with the help of a relay. Each communication path, whether between UE1 and the relay, the relay and UE2, or directly between UE1 and UE2, is marked as a “protected link.” This indicates that all data transmissions across these paths are secured using encryption and other security measures, as per the security keys established between the parties. Since UEs and relay are out of network coverage, there is no network entity to collect charging information for billing and charging. Each entity may maintain its own record for charging and accounting purposes. Each charging record may include time of link establishment, duration of the link, number of packets sent/received, etc., as illustrated in FIG. 8.

Some embodiments provide a method for maintaining charging records in a 5G Proximity Service where User Equipment (UE) devices are out of network coverage and are communicating via a relay. As illustrated in FIG. 8, since there is no active network entity available to collect the charging and billing information in real-time, each device, including UEs and the relay, is responsible for maintaining its own charging records. The charging records, as exemplified in the figure, may include various parameters related to the communication session. These parameters may include, but are not limited to: Time of link establishment between the first UEs and relay, duration of the communication link, the number of packets sent and/or received by each UE and the relay during the session. The charging records maintained by each entity (i.e., UET, UE2, and the relay) are securely stored until the devices return to the network coverage. Upon returning to the coverage area, the stored charging records are uploaded to the network charging and billing system, where they are processed to generate accurate billing for the services provided during the out-of-network communication. This ensures the integrity of billing information, even when the network is unable to monitor and collect real-time data during the period of out-of-network communication. FIG. 8 illustrates an example charging record maintained by a device during the proximity service session, capturing relevant data fields that are essential for billing once network connectivity is restored.

The charging records are securely stored in the first UEs and relay. To maintain an accurate charging record, the first UEs and relay may, based on network operator policy, exchange a copy of each other's secure charging record from time-to-time. The charging records are digitally signed (e.g., cryptographically signed) by the security keys shared between the two parties exchanging the charging record. FIG. 9 illustrates an example of UE1's signed charging record to be sent to UE2. Similarly, UE2 and relay will also exchange signed charging record with other entities respectively, e.g., UET exchanges with UE2, UET exchanges with relay, relay exchanges with UE2. UEs and relay will verify the validity of the charging record, reconcile the charging record, digitally sign the verified record, and secure store the charging record.

Some embodiments provide a method for securely storing and exchanging charging records in proximity services facilitated by 5G networks, particularly when User Equipment (UEs) and relays are out of network coverage. UEs and the relay securely store their charging records and, based on network operator policy, may periodically exchange copies of these records to ensure accuracy and consistency. Each charging record is cryptographically signed using security keys shared between the respective communicating parties. This ensures that the integrity and authenticity of the charging record are preserved during transmission. For example, as illustrated in FIG. 9, UE1's signed charging record is securely transmitted to UE2. Similarly, UE2 and the relay exchange their own signed charging records with other entities in the network, such as: UE1 exchanges its charging record with UE2, UE1 exchanges its charging record with the relay, the relay exchanges its charging record with UE2. Upon receiving a charging record, UEs and relays verify the digital signature to ensure the validity of the charging data. After verifying the record, the entities reconcile the charging data, digitally sign the verified record, and securely store it. This process guarantees the integrity of the charging records, allowing for secure, accurate, and indisputable billing once the devices return to network coverage and upload the records to the network charging system.

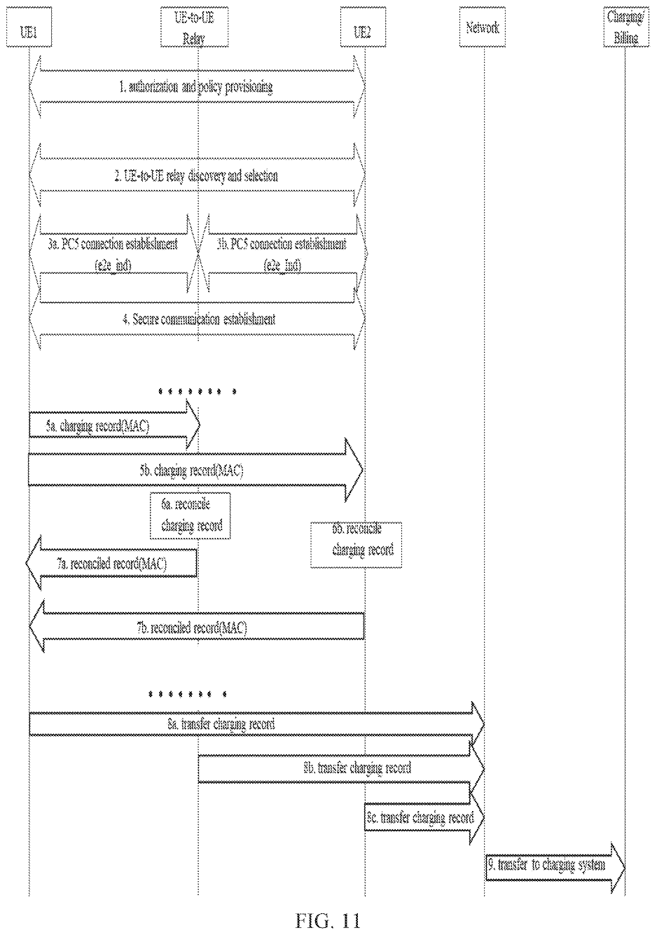

FIG. 10 illustrates an example of UE2 receiving and reconciling signed charging record from UE1. After UE2 reconciled the charging details, UE2 stores the reconciled charging record, signs it with UE2's own key and sends back the signed charging record to UE1 for secure storage. Reconciling the charging record is to prevent either the first UEs or relay incorrectly reporting the charging record. Reconciling can be done, for example, by UE1 verifying the amount of data or number of packets received against the first UE2's reported amount of data or number of packets send. Some embodiments provide a method for reconciling and securely exchanging charging records between UEs in proximity service. FIG. 10 illustrates the process where UE2 receives a digitally signed charging record from UE1. Upon receipt, UE2 verifies and reconciles the charging details to ensure the accuracy of the data exchanged between UE1 and UE2. The reconciliation process serves to prevent discrepancies or incorrect reporting of the charging record between the first UEs or between a UE and a relay. For instance, UE2 can reconcile the record by verifying the amount of data or the number of packets received against the data reported by UE1, ensuring consistency in the reported transmission data. After the reconciliation, UE2 digitally signs the reconciled charging record using UE2's own security key and sends the signed record back to UE1 for secure storage. This mutual verification and signing process strengthens the integrity of the charging records, preventing unauthorized or incorrect reporting and ensuring that both UEs maintain accurate and secure billing information.

FIG. 11 is an example of end-to-end communication call flow where UEs and relay maintain and reconcile charging records during an off-network communication session via a relay. FIG. 11 illustrates that, in some embodiments, the communication call flow includes at least one of the following operations.

Operation 1: authorization and provisioning (e.g., security parameters, security policies, and other parameters used for the two UEs to be able to establish communication) of UE1 and UE2. During this operation, UE1 and UE2 are provisioned with the necessary security parameters, security policies, and other relevant parameters required to establish secure communication between them. This involves the mobile network operator (MNO) or a trusted network entity authorizing both UEs for communication and provisioning them with security keys (e.g., cipher keys, integrity keys) and security policies. These parameters ensure that both UEs can engage in secure, encrypted communication and manage any proximity service, such as charging or data transmission, in a protected and controlled environment. The authorization step also includes verifying that both UEs are eligible for the service and that the security parameters comply with the network's security framework. This process establishes the foundation for secure communication between UE1 and UE2, enabling further steps, such as secure charging and data exchange, as described in the subsequent operations.

Operation 2: UE1 and UE2 discover a relay (example of UE-to-UE relay shown here). If there are multiple relays in the area, UE1 and UE2 select the relay that can provide relay service to them. In this operation, UE1 and UE2 perform the process of discovering a suitable relay in their vicinity to facilitate communication. This relay discovery is crucial for enabling the proximity service, particularly in cases where UE1 and UE2 are out of network coverage. UE1 and UE2 initiate the relay discovery process by broadcasting a relay discovery message. The relays in the surrounding area respond to this message, providing information about their availability and the relay service they can offer. The available relays may provide details such as signal strength, latency, or their capacity to handle traffic. If multiple relays are discovered, UE1 and UE2 evaluate the responding relays and select the one that best suits their communication needs. The selection criteria may include factors such as signal quality, relay load, proximity, and the relay's ability to securely transmit data between UE1 and UE2. Once the most appropriate relay is selected, UE1 and UE2 establish communication through this relay, preparing for the subsequent steps in secure communication and charging management. This operation ensures that both UEs have a reliable intermediary to facilitate their communication, even when they are outside direct network coverage.

Operations 3a and 3b: UE1 and UE2 establish PC5 connection with relay respectively. For illustrative purposes, the procedure here assumes that the communication between UE1 and UE2 are to be secured end-to-end. In Operations 3a and 3b, UE1 and UE2 each establish a PC5 (ProSe) connection with the selected relay, allowing for secure communication between the devices. The procedure assumes that the communication between UE1 and UE2 will be secured end-to-end.

Operation 3a: UE1 to Relay Connection: UE1 initiates the establishment of a PC5 connection with the relay by sending a connection request. The relay, after receiving the request, responds with an acknowledgment and initiates the PC5 interface configuration to enable secure communication. Both UE1 and the relay negotiate and exchange security credentials (such as security keys, cipher keys, and integrity keys). These security parameters are critical to ensuring that the communication between UE1 and the relay is protected from potential attacks or tampering. Once the security credentials are successfully exchanged, a secure PC5 connection is established between UE1 and the relay. Operation 3b: UE2 to Relay Connection: Similarly, UE2 initiates the establishment of a PC5 connection with the same relay. UE2 sends a connection request to the relay, which responds with an acknowledgment and begins configuring the PC5 interface. Security credentials are also exchanged between UE2 and the relay to ensure that the communication path between them is secure. This exchange includes security keys and other parameters needed to maintain confidentiality and data integrity during communication. After the exchange of security information, a secure PC5 connection is established between UE2 and the relay. At this point, both UE1 and UE2 have secure PC5 connections with the relay. These connections serve as the foundation for secure end-to-end communication between UE1 and UE2, ensuring that all transmitted data is protected and cannot be intercepted or tampered with by third parties. This setup is essential for maintaining the confidentiality, integrity, and authenticity of the communication, especially in situations where the first UEs are out of network coverage. The secure connections with the relay allow the communication to be relayed between UE1 and UE2 while preserving end-to-end security.

Operation 4: UE1 and UE2 establish security credentials used for the two UE2 to start secure end-to-end communication. Details of how security credentials are established are of prior art and are omitted here. In Operation 4, UE1 and UE2 establish the necessary security credentials required for secure end-to-end communication. These security credentials are used to protect the communication between the two devices, ensuring the confidentiality, integrity, and authenticity of the data exchanged. Security Credentials: These may include, but are not limited to, encryption keys (e.g., cipher keys), integrity keys, and other security parameters necessary to secure the communication path. Establishment Process: The method of establishing the security credentials is considered part of prior art and is not detailed here. Typically, these credentials can be established using standardized procedures such as key exchanges, mutual authentication protocols, or the use of a trusted third-party entity (such as a mobile network operator) to provide secure keys. End-to-End Security: Once the security credentials are successfully established between UE1 and UE2, all data communicated between the two devices is encrypted and authenticated. This ensures that the communication remains secure, even if relayed through a third device, such as the relay. With the security credentials in place, UE1 and UE2 can now start secure end-to-end communication. Any data transmitted between the two devices is protected from unauthorized access or modification, ensuring that only the intended parties (UE1 and UE2) can decrypt and validate the integrity of the data. By establishing these security credentials, the communication between UE1 and UE2 is protected against potential attacks, such as eavesdropping or data tampering, providing a secure communication path over which sensitive information can be exchanged.

Operations 5a and 5b: At some point during the secure communication session between UE1 and UE2, UE1 starts a procedure for reconciling UE1's charging record by sending a copy of its charging record to the relay and to UE2 respectively. The charging record is protected by computing a cryptographic hash MAC such that MAC=HASH(key)(charging record) and append the MAC to the charging record. The key used in computing the hash for charging record to be sent to the relay is the one that is used for protecting PC5 link between UE1 and the relay. The key used in computing the hash for charging record to be sent to UE2 is the one that is used for protecting the end-to-end communication between UE1 and UE2. The reconciliation between relay and UE2 is omitted for brevity. At a certain point during a secure communication session between UE1 and UE2, facilitated by a relay, UE1 initiates a procedure to reconcile its charging record. This reconciliation involves UE1 transmitting a copy of its charging record to both the relay and UE2. To ensure the security and integrity of the charging record, UE1 protects the charging record by generating a cryptographic Message Authentication Code (MAC) using a hash function.

Cryptographic Protection of Charging Records: For the Relay (Operation 5a): UE1 generates a MAC for the charging record intended for the relay using the cryptographic key shared between UE1 and the relay (used for securing the PC5 link). The MAC is computed as follows: MAC=HASH(key_relay)(charging record). The generated MAC is appended to the charging record, and the combined record is then transmitted securely to the relay. For UE2 (Operation 5b): Similarly, UE1 generates a MAC for the charging record intended for UE2, using the cryptographic key shared between UE1 and UE2 (used for securing the end-to-end communication). The MAC is computed as follows: MAC=HASH(key_UE2)(charging record). The MAC is appended to the charging record, and the combined record is then securely transmitted to UE2. Transmission and Verification: Upon receiving the charging record from UE1, both the relay and UE2 verify the validity of the record by using the appropriate cryptographic key to validate the MAC. This process ensures that the charging record has not been tampered with during transmission. Once the charging record is verified, the relay and UE2 store the verified charging record securely, ensuring that all entities maintain consistent and accurate records for billing and charging purposes. Omission of Relay-to-UE2 Reconciliation: The process of reconciling the charging record between the relay and UE2 is omitted for brevity in this description. However, such reconciliation can be implemented using a similar procedure to maintain secure and accurate charging records between the relay and UE2. This embodiment ensures secure and reliable charging record reconciliation for all entities involved, even in scenarios where network coverage is not available, thereby facilitating accurate billing once the first UEs reconnect to the network.

Operations 6a and 6b: The relay and UE2 verify the cryptographic hash MAC appended to the charging record using keys between UE1 and relay and between UE1 and UE2 respectively. The relay and UE2 reconcile the charging record received by comparing against similar charging record kept by relay and UE2 respectively, for example, comparing the number of bytes of data (or number of packets) received against the number of bytes of data (or number of packets) the other party sent. After reconciliation, the relay and UE2 send back the reconciled charging records back to UE1. During the secure communication session between UE1, the relay, and UE2, after receiving the charging record from UE1, both the relay and UE2 initiate a process to verify and reconcile the received charging record. The following describes the operations conducted by the relay and UE2 to ensure the integrity and accuracy of the charging records:

Verification of Cryptographic MAC: For the Relay (Operation 6a): The relay uses the cryptographic key shared between UE1 and itself (used for securing the PC5 link) to verify the cryptographic hash MAC appended to the charging record. The relay checks the validity of the charging record by computing the MAC using its shared key and comparing it to the received MAC: Computed MAC=HASH(key_relay)(charging record). If the computed MAC matches the received MAC, the relay confirms that the charging record has not been tampered with and proceeds to the reconciliation phase. For UE2 (Operation 6b): Similarly, UE2 verifies the cryptographic hash MAC appended to the charging record sent by UE1 using the cryptographic key shared between UE1 and UE2 (used for securing the end-to-end communication). UE2 computes the MAC as follows: Computed MAC=HASH(key_UE2)(charging record). If the computed MAC matches the received MAC, UE2 verifies the integrity of the charging record and proceeds with the reconciliation. Reconciliation of Charging Records: Relay and UE2: After verifying the charging records, the relay and UE2 compare the received charging record from UE1 against their own records. The reconciliation process typically involves verifying that the number of bytes (or number of packets) received corresponds to the number of bytes (or packets) that the other party has recorded as sent. This cross-verification ensures that both parties maintain consistent and accurate charging information. Transmission of Reconciled Charging Records to UE1: Once the relay and UE2 successfully reconcile the charging record with their own records, they generate a reconciled charging record and cryptographically sign it using their respective keys. The reconciled charging record is then securely transmitted back to UE1, ensuring that all three parties (UE1, UE2, and the relay) maintain identical and verified charging records. This process ensures the integrity, accuracy, and security of the charging records for the proximity service, allowing the mobile network operator (MNO) to later collect reliable billing information when the devices return to network coverage. The reconciliation between relay and UE2 ensures that discrepancies in charging records are avoided and that each party maintains consistent records for billing purposes.

Operations 7a and 7b: The relay and UE2 send back the reconciled charging records that are protected by a cryptographic hash using keys shared between UE1 and relay and between UE1 and UE2 respectively. At this point, the charging information in UE1, relay and UE2 are synchronized to a certain granularity. The granularity that is considered acceptable can be for example, accurate to a preset number of packets or bytes based on operator policy. During Operations 7a and 7b, after verifying and reconciling the charging records as described in the previous operations, the relay and UE2 send the reconciled charging records back to UE1. These records are securely transmitted using cryptographic protection to ensure the integrity and confidentiality of the charging data.

Operation 7a (Relay): The relay generates a reconciled charging record based on the comparison of its own records with the charging record received from UE1. Once the charging record is reconciled, the relay appends a cryptographic hash using the key shared between UE1 and the relay (used for protecting the PC5 link). The hash is computed as follows: MAC=HASH(key_relay)(reconciled charging record). The relay then securely sends the reconciled and hashed charging record back to UE1. Operation 7b (UE2): Similarly, UE2 generates a reconciled charging record after comparing its own records with the charging record received from UE1. After the reconciliation process, UE2 computes a cryptographic hash using the key shared between UE1 and UE2 (used for securing the end-to-end communication). The hash is computed as: MAC=HASH(key_UE2)(reconciled charging record). UE2 then securely transmits the reconciled charging record back to UE1, appending the computed MAC for protection. Synchronization of Charging Information: Upon receiving the reconciled charging records from the relay and UE2, UE1 now holds synchronized charging data with both the relay and UE2. This synchronization ensures that the charging information across all three entities (UE1, relay, and UE2) is aligned to a certain level of granularity. The granularity of synchronization can be defined based on the network operator's policy. For example, it can be accurate to a preset number of packets or bytes transmitted during the communication session. This level of accuracy ensures that minor discrepancies, such as differences in counting individual bytes or packets, are minimized and within acceptable tolerances set by the operator. At this point, the charging records across UE1, relay, and UE2 are consistent and securely stored, allowing for accurate and reliable billing when the devices return to network coverage. The cryptographic protection used throughout the process ensures that the integrity of the charging information is preserved, making the records tamper-resistant and reliable for billing purposes. This method provides a secure and efficient mechanism for maintaining and reconciling charging records in 5G proximity services when devices are outside network coverage.

Operations 5a to 7b can be repeated during preset intervals to maintain and update charging records kept at the first UEs and relay to increase accuracy. Since charging records for the same communication session is maintained at three different entities, it reduces the likelihood of fraud and dispute.

Operations 8a, 8b, and 8c: At the end of the communication and when UEs and relays are back at network coverage, the first UEs and relay transfer the charging record to the network. In Operations 8a, 8b, and 8c, once the communication session between UE1, UE2, and the relay has ended and all entities are back within network coverage, the first UEs and the relay begin the process of transferring their respective charging records to the network for billing and record-keeping purposes. Operation 8a (UE1): Upon re-entering network coverage, UE1 initiates a secure transfer of its reconciled charging records to the network. The charging records contain information such as the duration of the communication, the number of packets or bytes transmitted, and other usage-related details. The charging record is securely transmitted to the network's billing system using the appropriate secure communication channel. The network verifies the authenticity and integrity of the charging record using cryptographic methods (e.g., digital signatures or MACs appended during the reconciliation process). Operation 8b (Relay): Similarly, the relay, upon returning to network coverage, securely transfers its reconciled charging records to the network. The relay's charging record includes details of the communication session between the first UEs and any data relayed. Like UE1, the relay uses a secure channel to send its charging record to the network's billing system. The network performs validation checks on the received record to ensure its authenticity and accuracy. Operation 8c (UE2): UE2, after returning to network coverage, also securely transfers its charging record to the network. The charging record contains usage data related to the communication session and is transmitted via a secure channel. The network verifies the charging record from UE2 and compares it with the records received from UE1 and the relay to ensure consistency across all entities involved in the communication session. Upon receiving the charging records from UE1, UE2, and the relay, the network billing system processes the information and generates a final bill for the users based on the accumulated data. The secure transmission and validation of the charging records ensure that the information is tamper-proof and reliable for accurate billing. This process provides a seamless way to account for services rendered during out-of-network communication sessions, enabling operators to charge subscribers appropriately once the first UEs and relay reconnect to the network.

Operation 9: The network collects and collates the charging records and transfer to charging and billing system for processing (e.g., generating a chargeable bill). In Operation 9, after receiving the charging records from UE1, UE2, and the relay (as described in Operations 8a, 8b, and 8c), the network begins the process of collecting and collating the charging information for final billing. The steps are as follows: Collection of Charging Records: The network system gathers the reconciled charging records transmitted by UE1, UE2, and the relay. These records include all relevant data points, such as session duration, number of packets sent/received, and any other usage metrics relevant to billing. Verification and Validation: The network cross-verifies the charging records from each entity (UE1, UE2, and the relay) to ensure consistency. This involves checking the data integrity using cryptographic hashes (MACs) that were appended during the reconciliation process. Any discrepancies between the records are flagged for further review or reconciliation according to the operator's policy. Collation and Transfer to Billing System: Once validated, the charging records are compiled into a comprehensive summary by the network. The collected data is then transferred to the charging and billing system. The billing system processes the charging records and calculates the associated charges based on the operator's billing model (e.g., usage-based billing, subscription, or flat-rate). Generation of the Bill: the billing system generates a chargeable bill for each subscriber (e.g., UE1, UE2) based on the accumulated service usage during the out-of-network communication. The bill is prepared and sent to the respective subscribers for payment. This operation ensures that the charging records from out-of-network communication sessions are securely collected, verified, and accurately billed to the users once network coverage is re-established.

In summary, some embodiments of the present disclosure offer significant advantages to network operators by providing secure, reliable, and indisputable charging records for proximity services used by subscribers. The security of the charging process is founded on the secure communication setup established between UEs and the relay when the network is unavailable, ensuring that communication between UEs via the relay remains protected. During the communication session, UEs and the relay repeatedly exchange and reconcile charging records, which are protected cryptographically through security keys shared between the first UEs and between the first UE and relay. Since the charging records for the same communication session are maintained across three separate entities (UE1, UE2, and the relay), the risk of fraud and disputes is significantly reduced. As a result, the charging records are secure, reliable, and indisputable, benefiting the operator in billing for proximity services. One alternative to charging for proximity services is flat-rate billing. However, this approach is inflexible and lacks adaptability to varying usage patterns. In traditional wireless services, charging records are generated and maintained by network components, making detailed billing feasible. However, if flat-rate charging is applied, the flexibility to provide usage-based billing or other detailed billing methods for proximity services in 5G is lost. Without such alternatives, accurate, itemized billing becomes difficult to achieve in proximity services.

Commercial interests for some embodiments are as follows. 1. Solve issues in the prior art. 2. Solve other issues. 3. Provide secure charging. 4. Provide a good communication performance. 5. Provide high reliability. 6. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as an AIoT device, a node (UE/BS), and/or a communication system. Compatible products follow at least one proposed solution, method, system, and apparatus of some embodiments of the present disclosure. The proposed solution, method, system, and apparatus are widely used in an AIoT device, a node (UE/BS), and/or a communication system. With the implementation of the at least one proposed solution, method, system, and apparatus of some embodiments of the present disclosure, at least one modification to communication methods and apparatus are considered for standardizing.

FIG. 12 is an example of a computing device 1400 according to an embodiment of the present disclosure. Any suitable computing device can be used for performing the operations described herein. For example, FIG. 12 illustrates an example of the computing device 1400 that can implement apparatuses and methods of the above embodiments of FIGS. 1 to 10, using any suitably configured hardware and/or software. In some embodiments, the computing device 1400 can include a processor 1412 that is communicatively coupled to a memory 1414 and that executes computer-executable program code and/or accesses information stored in the memory 1414. The processor 1412 may include a microprocessor, an application-specific integrated circuit (“ASIC”), a state machine, or other processing device. The processor 1412 can include any of a number of processing devices, including one. Such a processor can include or may be in communication with a computer-readable medium storing instructions that, when executed by the processor 1412, cause the processor to perform the operations described herein.

The memory 1414 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1400 can also include a bus 1416. The bus 1416 can communicatively couple one or more components of the computing device 1400. The computing device 1400 can also include a number of external or internal devices such as input or output devices. For example, the computing device 1400 is illustrated with an input/output (“I/O”) interface 1418 that can receive input from one or more input devices 1420 or provide output to one or more output devices 1422. The one or more input devices 1420 and one or more output devices 1422 can be communicatively coupled to the I/O interface 1418. The communicative coupling can be implemented via any suitable manner (e.g., a connection via a printed circuit board, connection via a cable, communication via wireless transmissions, etc.). Non-limiting examples of input devices 1420 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1422 include a liquid crystal display (LCD) screen, an external monitor, a speaker, or any other device that can be used to display or otherwise present outputs generated by a computing device.

The computing device 1400 can execute program code that configures the processor 1412 to perform one or more of the operations described above with respect to methods of the above embodiments of FIGS. 1 to 10. The program code may be resident in the memory 1414 or any suitable computer-readable medium and may be executed by the processor 1412 or any other suitable processor.

The computing device 1400 can also include at least one network interface device 1424. The network interface device 1424 can include any device or group of devices suitable for establishing a wired or wireless data connection to one or more data networks 1428. Non limiting examples of the network interface device 1424 include an Ethernet network adapter, a modem, and/or the like. The computing device 1400 can transmit messages as electronic or optical signals via the network interface device 1424.

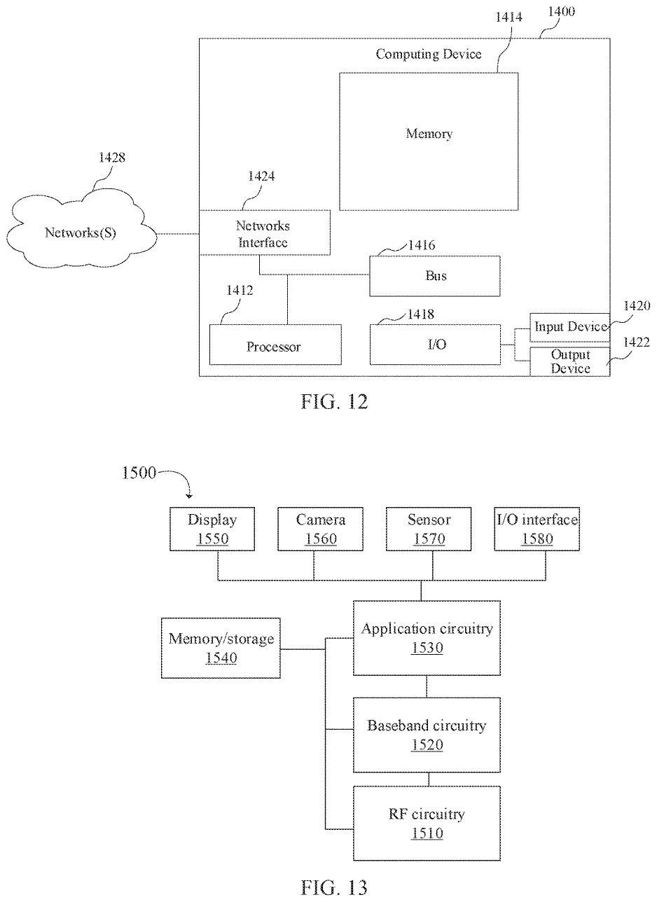

FIG. 13 is a block diagram of an example of a communication system 1500 according to an embodiment of the present disclosure. Embodiments described herein may be implemented into the communication system 1500 using any suitably configured hardware and/or software. FIG. 13 illustrates the communication system 1500 including a radio frequency (RF) circuitry 1510, a baseband circuitry 1520, an application circuitry 1530, a memory/storage 1540, a display 1550, a camera 1560, a sensor 1570, and an input/output (I/O) interface 1580, coupled with each other at least as illustrated.

The application circuitry 1530 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1500 can execute program code that configures the application circuitry 1530 to perform one or more of the operations described above with respect to methods of the above embodiments of FIGS. 1 to 10. The program code may be resident in the application circuitry 1530 or any suitable computer-readable medium and may be executed by the application circuitry 1530 or any other suitable processor.

The baseband circuitry 1520 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1520 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1510 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1510 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and methods of the above embodiments of FIGS. 1 to 10 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1540 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1580 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1570 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1550 may include a display, such as a liquid crystal display and a touch screen display. In various embodiments, the communication system 1500 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method of charging by a first user equipment (UE), comprising:
performing an authorization and policy provisioning with a second UE;
performing a UE-to-UE relay discovery and selection with the second UE;
establishing a link with a relay providing a relay service to the first UE and the second UE;
establishing security credentials to start a secure communication with the second UE; and
starting a procedure for reconciling a charging record by sending a copy of a charging record to the relay and the second UE during the secure communication.

2. The wireless communication method of claim 1, wherein performing the authorization and policy provisioning with the second UE comprises:
obtaining security parameters, security policies, and/or parameters used for the first UE to be able to establish communication with the second UE.

3. The wireless communication method of claim 1, wherein performing the first UE-to-UE relay discovery and selection with the second UE comprises:
discovering one or more relays and selecting the relay providing the relay service to the first UE and the second UE.

4. The wireless communication method of claim 1, wherein the secure communication between the first UE and the second UE is a secure end-to-end communication.

5. The wireless communication method of claim 1, further comprising:
protecting the charging record by computing a cryptographic hash message authentication code (MAC), wherein the MAC is appended to the charging record.

6. The wireless communication method of claim 5, further comprising:
transmitting a first key to the relay, wherein the first key is used in computing the cryptographic hash MAC for the charging record and is used for protecting the link between the first UE and the relay.

7. The wireless communication method of claim 6, further comprising:
transmitting a second key to the second UE, wherein the second key is used in computing the cryptographic hash MAC for the charging record and is used for protecting the secure communication between the first UE and the second UE.

8. The wireless communication method of claim 7, further comprising:
after reconciliation, the first UE receives reconciled charging records from the second UE and/or relay.

9. The wireless communication method of claim 8, wherein a charging information in the first UE, the relay, and the second UE is synchronized to a granularity.

10. The wireless communication method of claim 8, further comprising:
transferring the charging record to a network when the first UE is at a network coverage.

11. A first user equipment (UE), comprising:
an executor configured to perform an authorization and policy provisioning with a second UE and configured to perform a UE-to-UE relay discovery and selection with the second UE; and
an establisher configured to establish a link with a relay providing a relay service to the first UE and the second UE and configured to establish security credentials to start a secure communication with the second UE, wherein the executor is configured to start a procedure for reconciling a charging record by sending a copy of a charging record to the relay and the second UE during the secure communication.

12. The first UE of claim 11, wherein the executor is further configured to obtain security parameters, security policies, and/or parameters used for the first UE to be able to establish communication with the second UE.

13. The first UE of claim 11, wherein the executor is further configured to discover one or more relays and select the relay providing the relay service to the first UE and the second UE.

14. The first UE of claim 11, wherein the secure communication between the first UE and the second UE is a secure end-to-end communication.

15. The first UE of claim 11, wherein the executor is further configured to protect the charging record by computing a cryptographic hash message authentication code (MAC), wherein the MAC is appended to the charging record.

16. The first UE of claim 15, wherein the executor is further configured to transmit a first key to the relay, wherein the first key is used in computing the cryptographic hash MAC for the charging record and is used for protecting the link between the first UE and the relay.

17. The first UE of claim 16, wherein the executor is further configured to transmit a second key to the second UE, wherein the second key is used in computing the cryptographic hash MAC for the charging record and is used for protecting the secure communication between the first UE and the second UE.

18. The first UE of claim 17, wherein after reconciliation, the executor receives reconciled charging records from the second UE and/or relay.

19. The first UE of claim 18, wherein a charging information in the first UE, the relay, and the second UE is synchronized to a granularity.

20. The first UE of claim 18, wherein the executor is further configured to transfer the charging record to a network when the first UE is at a network coverage.

21. (canceled)
